(19) United States
(12) Patent Application Publication
(10) Pub. No.: US 2023/0081519 A1
(43) Pub. Date: Mar. 16, 2023

(54) END EFFECTOR, ROBOT, AND CONTROL METHOD OF THE END EFFECTOR

(71) Applicant: SEIKO EPSON CORPORATION, Tokyo (JP)

(72) Inventor: Hidetoshi SAITO, SUWA-GUN FUJIMI-MACHI (JP)

(21) Appl. No.: 17/941,031

(22) Filed: Sep. 9, 2022

(30) Foreign Application Priority Data
Sep. 10, 2021 (JP) 2021-147534

(51) Int. Cl. B25J 15/02; B25J 17/02; B25J 13/08

(52) U.S. Cl. CPC B25J 15/0253; B25J 13/082; B25J 17/02

(57) ABSTRACT

The end effector 10 includes a joint section 11 connected to a robotic arm 220, a working section 14 for performing work on an object 500, an actuator 40 is located between the joint section 11 and the working section 14 and moves the working section 14 in a first direction in which the joint section 11 and the working section 14 are aligned, a piezoelectric element 45 that drives an actuator 40.

The present application is based on, and claims priority from JP Application Serial Number 2021-147534, filed Sep. 10, 2021, the disclosure of which is hereby incorporated by reference herein in its entirety.

### BACKGROUND

### 1. Technical Field

The present disclosure relates to an end effector, a robot, and a control method of the end effector.

### 2. Related Art

For example, the robot hand controller described in JP-A-6-226671 has a force sensor for detecting each force applied to the X-axis, Y-axis and Z-axis of the robot hand, and three actuators for driving the robot hand in three axial directions respectively, and by driving and controlling the three actuators using signals from the force sensor, fine force control is possible and collision avoidance and constant control of the pressing force can be easily performed.

However, in the robot hand control device described in JP-A-6-226671, there is a problem that it is difficult to reduce the weight of the robot hand, since the force sensor is mounted on the robot hand, which is an end effector.

### SUMMARY

An end effector includes a joint section that is connected to a robotic arm, a working section that performs work on an object, an actuator that is located between the joint section and the working section and moves the working section in a first direction in which the joint section and the working section are aligned, and a piezoelectric element that drives the actuator.

A robot has the end effector described above.

A control method of the end effector including a joint section that is connected to a robotic arm, a working section that performs work on an object, an actuator that is between the joint section and the working section and moves the working section in a first direction in which the joint section and the working section are aligned, and a piezoelectric element that drives the actuator, the control method comprising, controlling a drive voltage of the piezo element such that a pressing force of the actuator becomes constant.

### BRIEF DESCRIPTION OF THE DRAWINGS

FIG. 1 is a perspective view showing an overall configuration of a robot system having an end effector according to a first embodiment.

FIG. 2 is a plan view illustrating the end effector according to the first embodiment.

FIG. 3 is a side view illustrating the end effector according to the first embodiment.

FIG. 4 is a sectional view taken along line A-A in FIG. 2.

FIG. 5 is a side view illustrating an actuator included in the end effector according to the first embodiment.

FIG. 6 is a diagram illustrating a relationship between thrust force and speed with respect to drive voltage applied to the actuator included in the end effector.

FIG. 7 is a diagram illustrating a relationship between the drive voltage and the thrust force when the actuator, mounted on the end effector, is driven at an extremely slow speed.

FIG. 8 is a plan view illustrating an end effector according to a second embodiment.

FIG. 9 is a sectional view taken along line B-B in FIG. 8.

FIG. 10 is a plan view illustrating an end effector according to a third embodiment.

FIG. 11 is a side view illustrating the end effector according to the third embodiment.

### DESCRIPTION OF EMBODIMENTS

### 1. First Embodiment

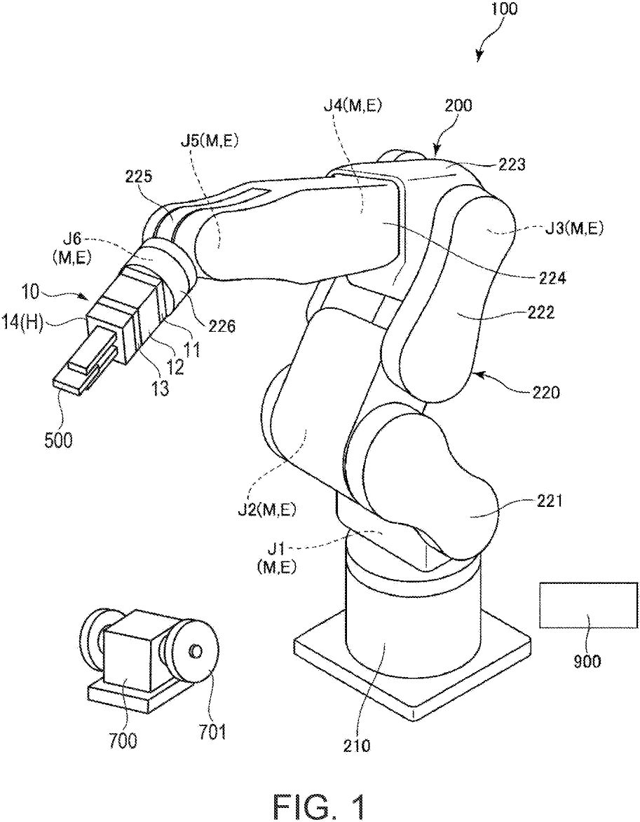

First, an end effector according to the first embodiment will be described with reference to FIGS. 1 to 5 by showing an end effector mounted on a robot of a robot system as one example.

For convenience of explanation, an X-axis, a Y-axis, and a Z-axis are illustrated as three axes orthogonal to each other in the following drawings except for FIGS. 1, 6, and 7. A direction along the X axis is referred to as an “X direction”, a direction along the Y axis is referred to as a “Y direction”, and a direction along the Z axis is referred to as a “Z direction”. In addition, an arrow mark direction of each axis is also referred to as a “plus direction”, and an opposite direction to the arrow mark direction is also referred to as a “minus direction”.

A robot system 100 illustrated in FIG. 1 includes a robot 200 that clamps an object 500, a robot control device 900 that controls driving of the robot 200, and a processing apparatus 700 that performs, for example, polishing processing on the object 500.

The robot 200 is a six-axis robot having six drive axes. The robot 200 includes a base 210 fixed to a floor, a robotic arm 220 connected to the base 210, and an end effector 10 connected to the robotic arm 220.

Further, the robotic arm 220 includes a plurality of arms 221, 222, 223, 224, 225, 226 which are rotatably connected, and six joints J1 to J6. Among them, the joints J2, J3, and J5 are bending joints, and the joints J1, J4, and J6 are torsional joints. In addition, a motor M, which is a drive source, and an encoder E, which detects an amount of rotation of the motor M or a angle of rotation of arm, are mounted in the joints J1, J2, J3, J4, J5, J6.

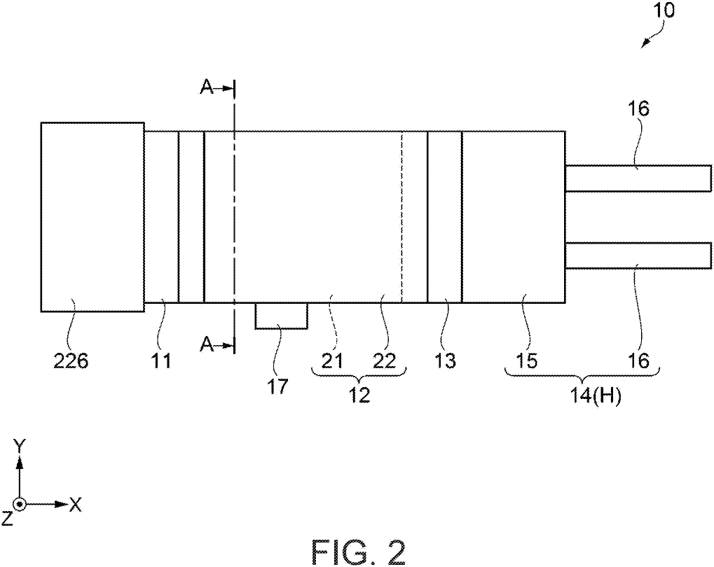

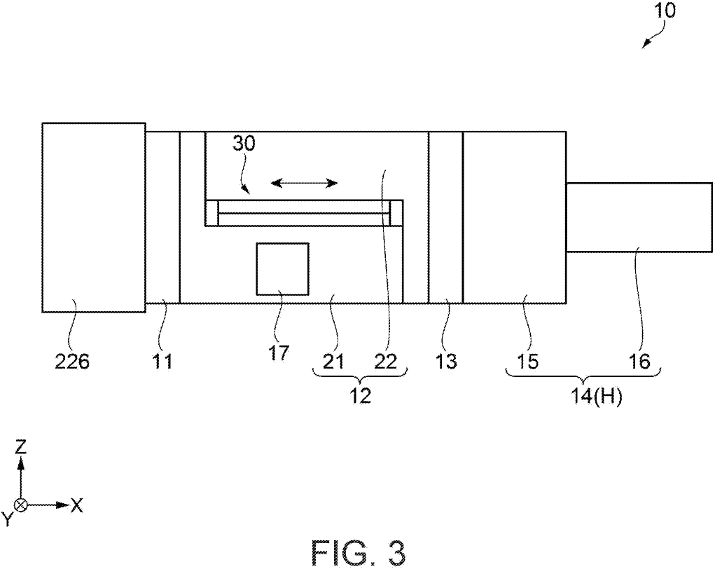

The end effector 10 is connected to the robotic arm 220 and, more specifically, is connected to a front end portion of the arm 226. As shown in FIGS. 2 and 3, the end effector 10 includes a joint section 11 that is connected to the arm 226, a movement stage 12 that moves a working section 14, a connection section 13 that connects the movement stage 12 and the working section 14, and the working section 14 that clamps an object 500.

The movement stage 12 is located between the joint section 11 and the working section 14, and moves the working section 14 in an X direction, which is a first direction in which the joint section 11 and the working section 14 are aligned. The movement stage 12 has a fixed section 21 fixed to the joint section 11, a movable section 22 that is mounted on the fixed section 21 through a linear guide 30 and that is fixed to the working section 14 through the connection section 13, and a control section 17 for controlling the movement of the movable section 22.

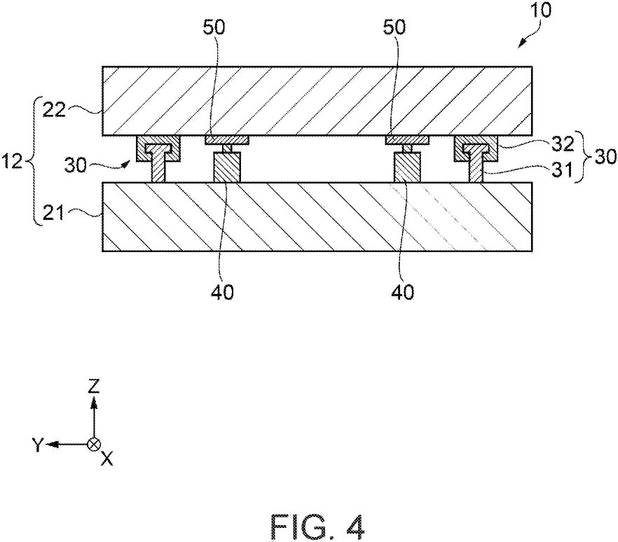

In the movement stage 12, as shown in FIG. 4, a rail 31 constituting the linear guide 30 for smoothly moving the movable section 22 in the X direction and an actuator 40 for moving the movable section 22 are mounted on the surface of the fixed section 21 facing the movable section 22. A guide 32 constituting the linear guide 30 and a protection plate 50 made of alumina or the like for protecting the movable portion 22 from contact with the actuator 40 are mounted on the surface of the movable section 22 facing the fixed section 21.

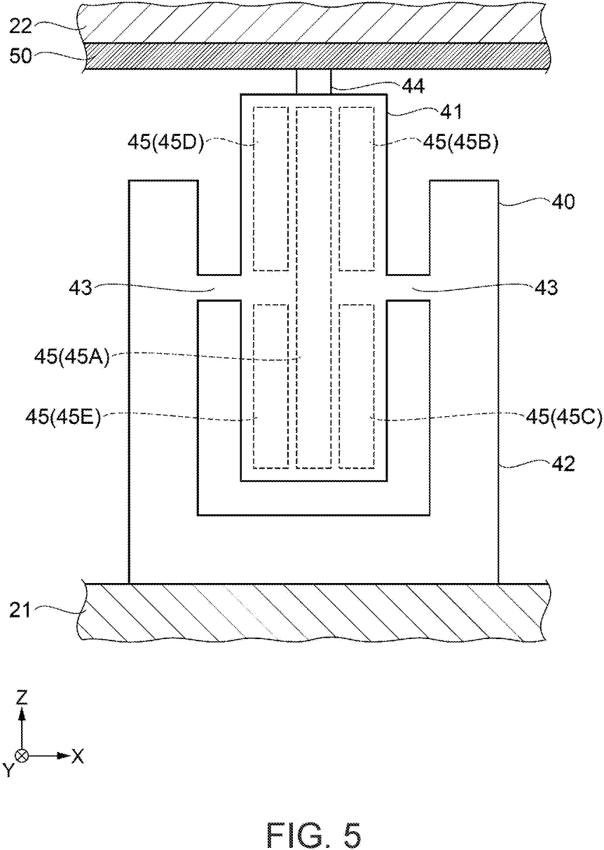

The actuator 40 is located between the joint section 11 and the working section 14, and moves the working section 14, which is connected to the movable section 22, in an X direction, that is the first direction in which the joint section 11 and the working section 14 are aligned. As shown in FIG. 5, the actuator 40 includes a vibrating member 41, a support member 42 that supports the vibrating member 41, a joint member 43 that connects the vibrating member 41 and the support member 42, a convex portion 44 that is provided on the vibrating member 41 and that transmits the vibration of the vibrating member 41 to a protection plate 50 on the movable section 22, and a piezoelectric element 45 that vibrates the vibrating member 41. Five piezoelectric elements 45A to 45E that drive the actuator 40 are arranged in the vibrating member 41. The drive of these five piezoelectric elements 45A to 45E is controlled by voltage, specifically, by drive voltage output from the control section 17, and each of five piezoelectric elements 45A to 45E expands and contracts in the Z direction, which is the longitudinal direction of the vibrating member 41. Therefore, by expanding and contracting each of the piezoelectric elements 45A to 45E at a predetermined timing, the vibrating member 41 undergoes S-shaped bending vibration, and this bending vibration is transmitted through the convex portion 44 to the protection plate 50 on the movable portion 22, whereby the movable section 22 can be moved to the plus direction or the minus direction in the X direction.

The control section 17 controls the drive voltage so as to make the pressing force constant, and drives the actuator 40 by applying the controlled drive voltage to the piezoelectric element 45.

The working section 14 includes a driving section 15 that drives a clamping unit 16 and the clamping unit 16 that clamps the object 500. The driving section 15 moves the clamping unit 16 in the Y direction, and the clamp unit 16 clamps the object 500. Accordingly, the working section 14 of this embodiment is the hand H.

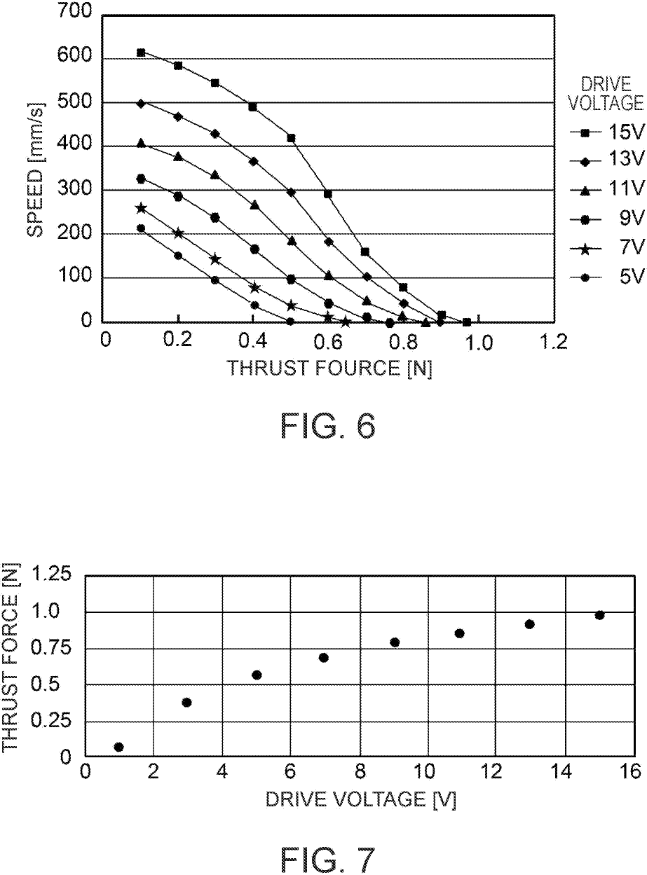

Here, a control method of the end effector 10 will be described with reference to FIGS. 6 and 7.

The thrust force and the speed of the actuator 40 using expansion and contraction of the piezoelectric element 45 vary as shown in FIG. 6 according to the drive voltage applied to the piezoelectric element 45. The thrust force is a pressing force with which the actuator 40 presses the working section 14 in the X direction, and the speed is a moving speed with which the actuator 40 moves the working section 14 in the X direction.

At an extremely low speed of speed 0, the thrust force of the actuator 40 becomes maximum, and the relationship between the drive voltage of the actuator 40 and the thrust force becomes as shown in FIG. 7.

Therefore, the control method of the end effector 10 controls the drive voltage of the piezoelectric element 45 so that the pressing force of the actuator 40 becomes constant. That is, if the thrust force, which is the pressing force when the object 500 contacts a rotating grinding wheel 701 and is polished, is determined, then the drive voltage corresponding to the thrust force can be determined from the relationship between the drive voltage and the thrust force shown in FIG. 7, and the pressing force of the actuator 40 can be made constant by controlling the drive voltage applied to the piezoelectric element 45. Therefore, the object 500 can be polished with high accuracy.

Calibration of the relationship between the speed and thrust force with respect to the pre-operation drive voltage will be described. The thrust force corresponding to the drive voltage is calibrated by installing, in the gravity direction, the end effector 10 clamping a weight of predetermined weight, detecting a drive voltage balanced with the thrust force caused by the predetermined weight, and comparing the detected drive voltage with the relationship between the thrust force and the drive voltage stored in the memory of the control section 17. Further, the speed corresponding to the drive voltage is calibrated by setting the end effector 10 horizontally in a posture which is free from the influence of gravity, detecting the maximum speed for each drive voltage in a no-load state, and comparing the detected speeds with the relationship between the speed and the drive voltage stored in the memory of the control section 17.

The robot control device 900 controls driving of the joints J1 to J6 and the end effector 10 to cause the robot 200 to perform a predetermined work. The robot control device 900 is configured by, for example, a computer, and includes a processor (CPU) that processes information, a memory that is communicably connected to the processor, and an external interface. Further, various programs which can be executed by the processor are stored in the memory, and the processor can read and execute the various programs and the like stored in the memory.

The processing apparatus 700 polishes the object 500 by pressing the object 500 against the rotating grinding wheel 701.

In the present embodiment, the object 500 is clamped by the end effector 10 and polished, but the present embodiment is not limited thereto, and the rotating grinding wheel 701 may be attached to the end effector 10 and the object 500 may be polished. The work is not limited to polishing work, and may be fitting work.

As described above, in the end effector 10 of the present embodiment, since the pressing force of the actuator 40 is made constant by controlling the drive voltage that drives the piezoelectric element 45, it is possible to reduce the weight of the end effector 10 as compared with an end effector in which a force sensor is mounted. In particular, if the actuator 40 driven by the piezoelectric element 45 has the same weight as one equipped with an electromagnetic motor, then it can generate several times the thrust force of the electromagnetic motor, so that the weight of the actuator 40 can be significantly reduced.

### 2. Second Embodiment

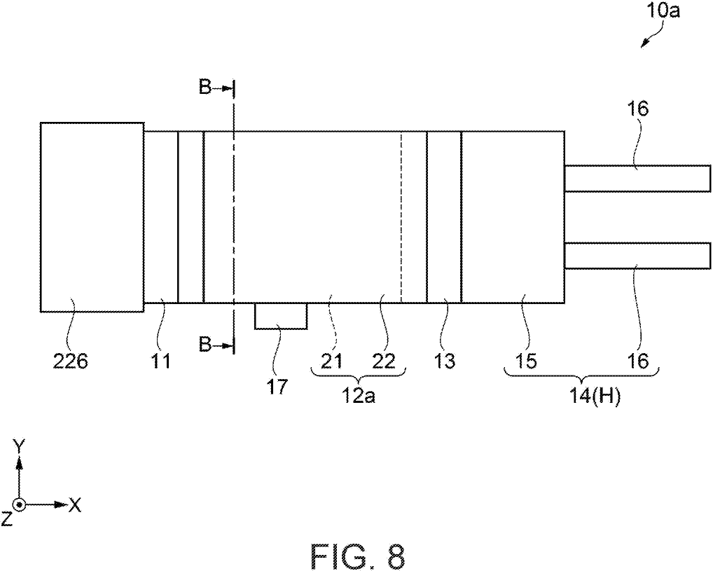

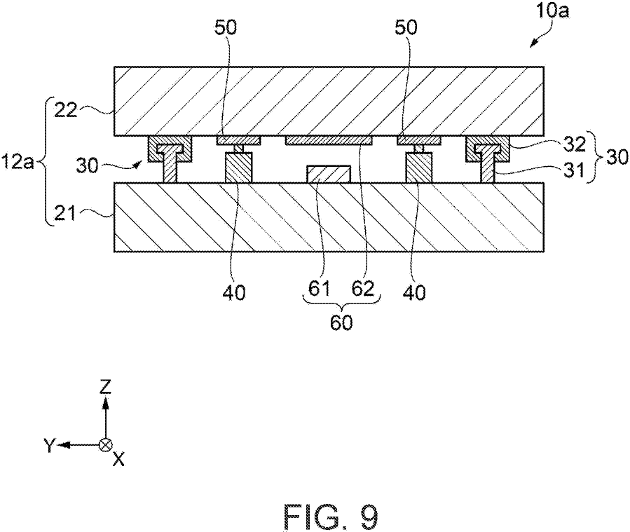

Next, an end effector 10a according to a second embodiment will be described with reference to FIGS. 8 and 9.

The end effector 10a of the present embodiment is the same as the end effector 10 of the first embodiment except that the configuration of a movement stage 12a is different from that of the end effector 10 of the first embodiment. The difference from the first embodiment described above will be mainly described, and the similar items will be designated by the same reference numerals and description thereof will be omitted.

As shown in FIG. 8, the end effector 10a includes the joint section 11 that is connected to the arm 226, the movement stage 12a that moves the working section 14, the connection section 13 that connects the movement stage 12a and the working section 14, and the working section 14 that clamps the object 500.

In the movement stage 12a, as shown in FIG. 9, the rail 31 constituting the linear guide 30 for smoothly moving the movable section 22 in the X direction, the actuator 40 for moving the movable section 22, and an encoder chip 61 constituting an encoder 60 for detecting the position and moving speed of the movable section 22 are mounted on the surface of the fixed section 21 facing the movable section 22. The guide 32 constituting the linear guide 30, the protection plate 50 made of alumina or the like for protecting the movable section 22 from contact with the actuator 40, and an encoder scale 62 constituting the encoder 60 are mounted on the surface of the movable section 22 facing the fixed section 21.

The control section 17 controls the drive voltage based on the signal from the encoder 60 and applies the controlled drive voltage to the piezoelectric element 45 to drive the actuator 40.

The control method of the end effector 10a controls drive voltage of the piezoelectric element 45 based on a signal from the encoder 60 so that the pressing force of the actuator 40 becomes constant.

When the object 500 clamped by the working section 14 is brought into contact with the rotating grinding wheel 701 of the processing apparatus 700 and polished, the pressing force of the actuator 40 can be made constant by the encoder 60 mounted on the movement stage 12a detecting the moving speed of the object 500 clamped by the working section 14, and controlling the drive voltage applied to the piezoelectric element 45 based on the relationship shown in FIG. 6 so as to generate a thrust force regulated by the detected speed.

With such a configuration, even if eccentricity of the rotating shaft of the grinding wheel 701 or vibration of the processing apparatus 700 occurs, the pressing force becomes constant, so that the polishing accuracy of the object 500 can be further improved.

### 3. Third Embodiment

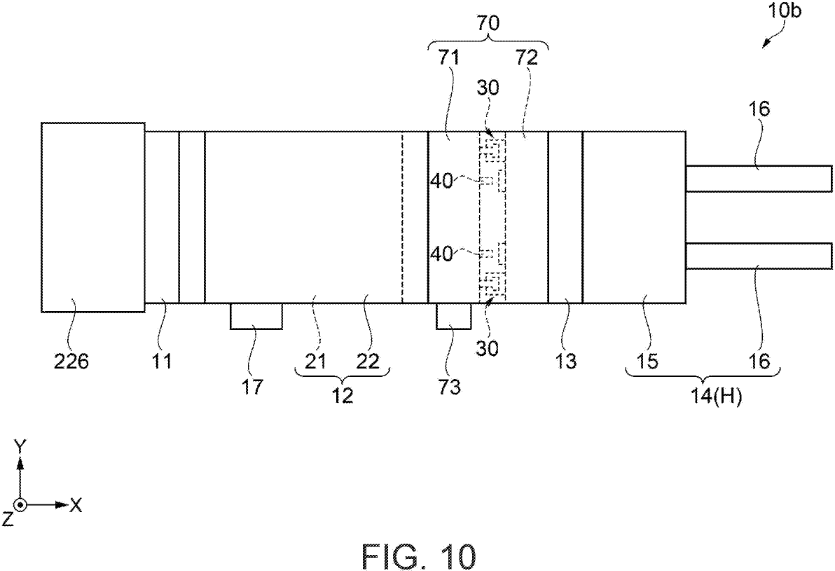

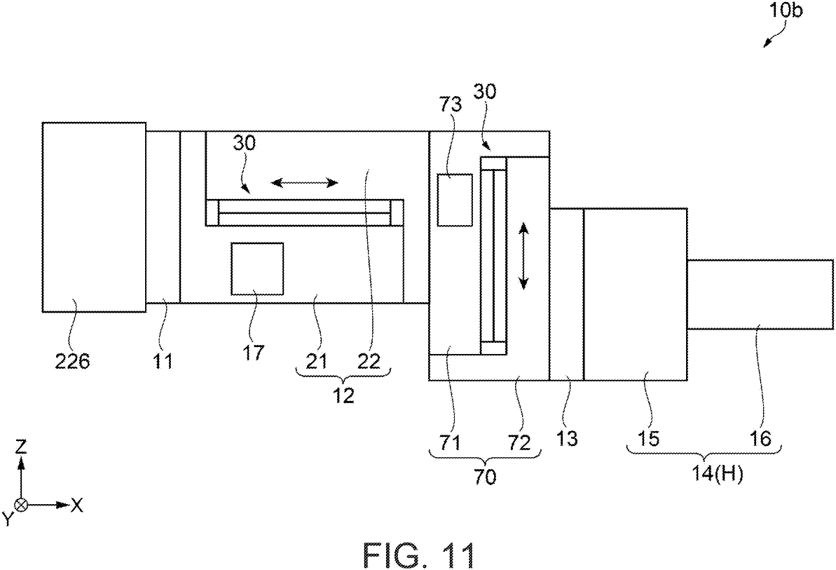

Next, an end effector 10b according to a third embodiment will be described with reference to FIGS. 10 and 11.

The end effector 10b of the present embodiment is the same as the end effector 10 of the first embodiment except that a movement stage 70 is added, as compared with the end effector 10 of the first embodiment. The difference from the first embodiment described above will be mainly described, and the similar items will be designated by the same reference numerals and description thereof will be omitted.

As shown in FIGS. 10 and 11, the end effector 10b includes the joint section 11 that is connected to the arm 226, the movement stage 12 that moves the working section 14 in the X direction, which is the first direction, the movement stage 70 that moves the working section 14 in the Z direction, which is the second direction, which is orthogonal to the first direction, the connection section 13 that connects the movement stage 70 and the working section 14, and the working section 14 that clamps the object 500. The movement stage 70 is located between the joint section 11 and the working section 14, and the actuator 40 for moving a movable section 72 is mounted on a surface of a fixed section 71 facing the movable section 72.

The movement stage 12 and the movement stage 70 are arranged between the joint section 11 and the working section 14, and the fixed section 71 of the movement stage 70 is fixed to the movable section 22 of the movement stage 12.

The movement of the movable section 22 of the movement stage 12 in the X direction is controlled by the control section 17. The movement of the movable section 72 of the movement stage 70 in the Z direction is controlled by a control section 73.

With such a configuration, it is possible not only to press the object 500 in a vertical direction against the grinding wheel 701 of the processing apparatus 700, but also to control by two axes a pressing force in an oblique direction, and it is also possible to polish a corner portion such as chamfering.

What is claimed is:

1. An end effector, comprising:
a joint section that is connected to a robotic arm;
a working section that performs work on an object;
an actuator that is located between the joint section and the working section and that moves the working section in a first direction in which the joint section and the working section are aligned; and
a piezoelectric element that drives the actuator.

2. The end effector according to claim 1, wherein:
drive of the piezoelectric element is controlled by voltage.

3. The end effector according to claim 1, further comprising:
an actuator that is located between the joint section and the working section and that moves the working section in a second direction orthogonal to the first direction.

4. The end effector according to claim 1, further comprising:
an encoder, wherein:
the actuator is driven by a drive voltage controlled based on a signal from the encoder.

5. The end effector according to claim 4, further comprising:
a control unit that controls the drive voltage.

6. The end effector according to claim 1, wherein:
the working section is a hand.

7. A robot, comprising:
the end effector according to claim 1.

8. A control method of an end effector including
a joint section that is connected to a robotic arm, a working section that performs work on an object, an actuator that is located between the joint section and the working section and that moves the working section in a first direction in which the joint section and the working section are aligned, and a piezoelectric element that drives the actuator,
the control method comprising:
controlling drive voltage of the piezoelectric element so that pressing force of the actuator becomes constant.
